(19) United States
(12) Patent Application Publication
(10) Pub. No.: US 2023/0306294 A1
(43) Pub. Date: Sep. 28, 2023

(54) DETERMINATION OF QUANTUM NOISE INTENSITY

(71) Applicant: BEIJING BAIDU NETCOM SCIENCE TECHNOLOGY CO., LTD., Beijing (CN)

(72) Inventors: Kun WANG, Beijing (CN); Shuanghong TANG, Beijing (CN)

(73) Assignee: BEIJING BAIDU NETCOM SCIENCE TECHNOLOGY CO., LTD., Beijing (CN)

(21) Appl. No.: 18/202,156

(22) Filed: May 25, 2023

(30) Foreign Application Priority Data
May 31, 2022 (CN) 20221061421.5

(51) Int. Cl. G06N 10/20

(52) U.S. Cl. CPC G06N 10/20

(57) ABSTRACT

A method is provided. The method includes: obtaining a maximally mixed state; repeatedly running a quantum measurement device to perform measurement for a first number of times on the maximally mixed state to obtain first measurement results; applying a phase gate to each quantum bit of the maximal superposition state; performing multiple times of sampling on the phase θ, for each value of θ obtained by sampling, repeatedly running the quantum measurement device to perform measurement for a second number of times on the maximal superposition state to obtain second measurement results; statistically calculating the first measurement result and the second measurement result corresponding to each θ value to obtain a first probability value and a second probability value; and determining the quantum noise intensity of the quantum measurement device based on a difference value between the first probability value and the second probability value.

### CROSS REFERENCE TO RELATED APPLICATIONS

The present application claims priority to Chinese Patent Application No. 202210614321.5 filed on May 31, 2022, the contents of which is hereby incorporated by reference in its entirety for all purposes.

### TECHNICAL FIELD

The present disclosure relates to the field of quantum computers and especially relates to the technical field of quantum error mitigation, in particular to a method and apparatus for determining a quantum noise intensity of a quantum measurement device, an electronic device, a computer-readable storage medium and a computer program product.

### BACKGROUND

A quantum computer technology has gone through fast development in recent years, but a noise problem is inevitable in a foreseeable future quantum computer, heat dissipation in quantum bits or random fluctuation occurring in a lower-layer quantum physical process will make states of the quantum bits flip or be randomized, and a computing result read by a measurement device has a deviation, which may lead to failure in a computing process.

Specifically, due to the limit of various factors such as instruments, methods and conditions, a quantum measurement device cannot operate with precision, thus causing measurement noise, and deviation in actual measurement value. Therefore, the effect of measurement noise needs to be reduced to achieve unbiased estimation of the measurement result.

### SUMMARY

The present disclosure provides a method and apparatus for determining a quantum noise intensity of a quantum measurement device, an electronic device, a computer-readable storage medium and a computer program product.

According to an aspect of the present disclosure, a method for determining a quantum noise intensity of a quantum measurement device is provided and includes: obtaining a n-qubit maximally mixed state, wherein n is a quantity of quantum bits of the quantum measurement device; repeatedly running the quantum measurement device to perform measurement for a first number of times on the maximally mixed state to obtain first measurement results; obtaining a n-qubit maximal superposition state; applying a phase gate to each quantum bit of the maximal superposition state, wherein the phase gate includes an adjustable phase θ; performing multiple times of sampling on the phase θ, and for each value of θ obtained by sampling, repeatedly running the quantum measurement device to perform measurement for a second number of times on the maximal superposition state to which the corresponding phase gate is applied, to obtain second measurement results; statistically calculating the first measurement results to obtain a first probability value of occurrence of each of at least one measurement result corresponding to the maximally mixed state; statistically calculating the second measurement results corresponding to each value of θ to obtain a second probability value of occurrence of each of at least one measurement result corresponding to the maximal superposition state; and determining the quantum noise intensity of the quantum measurement device based on a difference value between the first probability value and the second probability value.

According to another aspect of the present disclosure, a method for error mitigation of a quantum measurement device is provided and includes: determining a quantum noise intensity of the quantum measurement device; and performing error mitigation on the quantum measurement device through a quantum measurement device tomography method or a quantum measurement device calibration method based on the determined quantum noise intensity, wherein the quantum noise intensity of the quantum measurement device is determined by implementing operations including: obtaining a n-qubit maximally mixed state, wherein n is a quantity of quantum bits of a quantum measurement device; repeatedly running the quantum measurement device to perform measurement for a first number of times on the maximally mixed state to obtain first measurement results; obtaining a n-qubit maximal superposition state; applying a phase gate to each quantum bit of the maximal superposition state, wherein the phase gate comprises an adjustable phase θ; performing multiple times of sampling on the phase θ, and for each value of θ obtained by sampling, repeatedly running the quantum measurement device to perform measurement for a second number of times on the maximal superposition state to which the corresponding phase gate is applied, to obtain second measurement results; statistically calculating the first measurement results to obtain a first probability value of occurrence of each of at least one measurement result corresponding to the maximally mixed state; statistically calculating the second measurement results corresponding to each value of θ to obtain a second probability value of occurrence of each of at least one measurement result corresponding to the maximal superposition state; and determining a quantum noise intensity of the quantum measurement device based on a difference value between the first probability value and the second probability value.

According to another aspect of the present disclosure, an electronic device is provided and includes: a memory storing one or more programs configured to be executed by one or more processors, the one or more programs including instructions for causing the electronic device to perform operations comprising: obtaining a n-qubit maximally mixed state, wherein n is a quantity of quantum bits of a quantum measurement device; repeatedly running the quantum measurement device to perform measurement for a first number of times on the maximally mixed state to obtain first measurement results; obtaining a n-qubit maximal superposition state; applying a phase gate to each quantum bit of the maximal superposition state, wherein the phase gate comprises an adjustable phase θ; performing multiple times of sampling on the phase θ, and for each value of θ obtained by sampling, repeatedly running the quantum measurement device to perform measurement for a second number of times on the maximal superposition state to which the corresponding phase gate is applied, to obtain second measurement results; statistically calculating the first measurement results to obtain a first probability value of occurrence of each of at least one measurement result corresponding to the maximally mixed state; statistically calculating the second measurement results corresponding to each value of θ to obtain a second probability value of occurrence of each of at least one measurement result corresponding to the maximal superposition state; and determining a quantum noise intensity of the quantum measurement device based on a difference value between the first probability value and the second probability value.

It should be understood that the contents described in this part are neither intended to identify key or important features of the embodiments of the present disclosure, nor used to limit the scope of the present disclosure. Other features of the present disclosure will be easier to understand through the following specification.

### BRIEF DESCRIPTION OF THE DRAWINGS

Accompanying drawings, which constitute a part of the specification, exemplarily illustrate embodiments and, together with text description of the specification, serve to explain exemplary implementations of the embodiments. The illustrated embodiments are only intended to serve as examples without limiting the scope of the claims. In all the drawings, the same reference numbers represent similar but not necessarily the same elements.

FIG. 1 shows a schematic diagram of an exemplary system where various methods described herein can be implemented according to an embodiment of the present disclosure.

FIG. 2 shows a flowchart of error mitigation through a quantum measurement device calibration method according to an embodiment of the present disclosure.

FIG. 3 shows a flowchart of a method for determining a quantum noise intensity of a quantum measurement device according to an embodiment of the present disclosure.

FIG. 4 shows a schematic diagram of a quantum circuit for obtaining a maximally mixed state according to an embodiment of the present disclosure.

FIG. 5 shows a schematic diagram of a quantum circuit for obtaining a modulated maximal superposition state according to an embodiment of the present disclosure.

FIG. 6 shows a schematic diagram of a noise curve and a fitted curve obtained through simulation according to an embodiment of the present disclosure,

FIG. 7 shows a flowchart of a method for error mitigation of a quantum measurement device according to an embodiment of the present disclosure.

FIG. 8 shows a structural block diagram of an apparatus for determining a quantum noise intensity of a quantum measurement device according to an embodiment of the present disclosure.

FIG. 9 shows a structural block diagram of an apparatus for error mitigation of a quantum measurement device according to an embodiment of the present disclosure.

FIG. 10 shows a structural block diagram of an exemplary electronic device capable of being used for implementing embodiments of the present disclosure.

### DETAILED DESCRIPTION

Embodiments of the present disclosure are described below with reference to the accompanying drawings, which include various details of the embodiments of the present disclosure for better understanding and should be regarded as only exemplary. Therefore, those ordinarily skilled in the art should realize that various changes and modifications can be made to embodiments described herein without departing from the scope of the present disclosure. Similarly, for the sake of being clear and concise, description of known functions and structures is omitted in the following description.

In the present disclosure, unless otherwise stated, terms such as “first” and “second” used for describing various elements are not intended to limit a position relation, a timing sequence relation or a significance relation of these elements and are only used for distinguishing one component from another component. In some examples, a first element and a second element may refer to the same instance of the elements, which, in some cases, may also refer to different instances on the basis of description of the context.

Terms used in description of various examples in the present disclosure are only intended to describe specific examples but not intended to make a limitation. Unless otherwise indicated clearly in the context, if the quantity of elements is not limited in particular, there may be one or a plurality of the elements. Besides, a term “and/or” used in the present disclosure covers any one or all possible combinations in listed items.

The embodiments of the present disclosure will be described in detail below with reference to the accompanying drawings.

So far, various different types of computers under application use classical physics as a theoretical basis of information processing, which are called a traditional computer or a classical computer. A classical information system uses binary data bits easiest to realize physically to store data or programs, and each binary data bit is represented by 0 or 1, called a bit and serving as a smallest information unit. The classical computer has inevitable weaknesses per se, one of which is a most basic limit of energy consumption of a computing process. Lowest energy needed by a logic element or a storage unit should be more than several times that of kT so as to avoid a mis-operation under thermal fluctuation; secondly, there are an information entropy and heating energy consumption; and thirdly, when a wiring density of a computer chip is very large, an uncertainty of a momentum will be very large when an uncertainty of an electron location is very small according to a Heisenberg uncertainty relation. Electrons are not restrained any more, and there may be a quantum interference effect which may even destroy performance of a chip.

The quantum computer is a type of physical devices which perform high-speed mathematic and logic operations and storage and processing of quantum information by conforming to quantum mechanical properties and laws. A certain device, which processes and computes quantum information and runs a quantum algorithm, is the quantum computer. The quantum computer conforms to a unique law of quantum dynamics (especially, quantum interference) to realize a new mode of information processing. As for parallel processing of a computing problem, the quantum computer has a speed absolute predominance compared to the classical computer. A transformation realized for each superimposed component by the quantum computer is equivalent to classical computations, all these classical computations are completed at the same time and superimposed according to a certain probability amplitude, and an output result of the quantum computer is given, so this type of computing is called a quantum parallel computing. Quantum parallel processing greatly improves an efficiency of the quantum computer and enables the quantum computer to complete work which cannot be completed by the classical computer, such as factorization of a very big natural number. A quantum coherence is utilized in nature in all super-fast quantum algorithms. Therefore, the quantum parallel computing using a quantum state to replace a classical state can achieve incomparable operating rate and information processing functions compared to the classical computer, and meanwhile, a mass of computing resources are saved.

With rapid development of quantum computer technology, an application range of the quantum computer is increasingly wide due to its powerful computing capacity and high running speed. For example, chemical simulation refers to a process of mapping Hamiltonian of a real chemical system onto a physically operable Hamiltonian, and then modulating parameters and evolutionary time so as to find an eigen state which can reflect the real chemical system. When an N electron chemical system is simulated on the classical computer, it involves solving of a 2^{N}-dimension Schrodinger's equation, and a computing amount may increase exponentially with increase of the quantity of electrons of the system. Therefore, the classical computer has very limited functions in terms of the chemical simulation problem. To break through the bottleneck, it must depend on the powerful computing capacity of the quantum computer. A variational quantum eigensolver (VQE) is an efficient quantum algorithm for chemical simulation on quantum hardware, is one of recent most promising applications of the quantum computer and opens many new chemical research fields. However, a measurement noise rate of the quantum computer at the present stage obviously limits capacity of the VQE, so a problem of quantum measurement noise must be handled first.

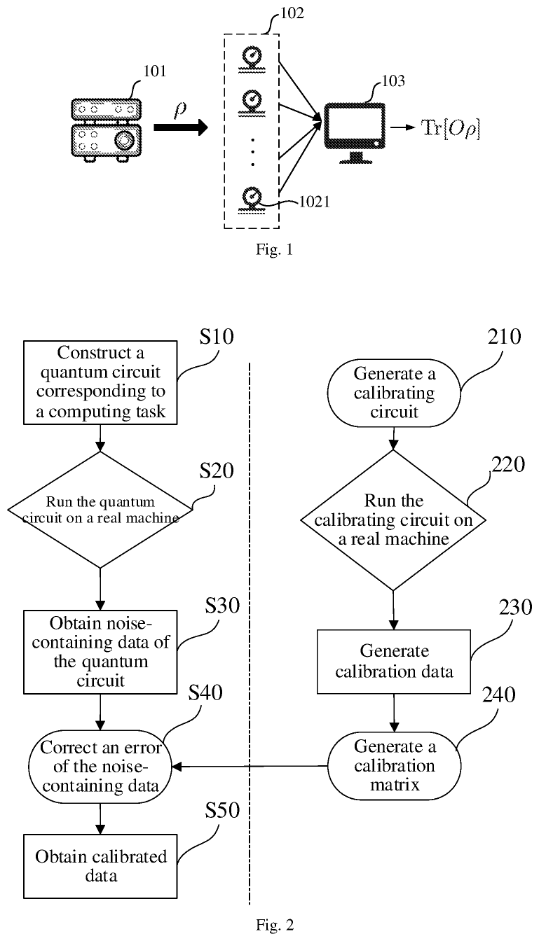

A core computing process of the VQE is to estimate an expected value Tr[Op], where p is a n-qubit quantum state generated by the quantum computer, and an observable quantity O is a physically operable Hamiltonian that the Hamiltonian of the real chemical system mapped to. The above process is a most common mode of extracting classical information by quantum computing, which is widely applied and may be regarded as a core step of reading the classical information from the quantum information. In general, it may be assumed that O is a diagonal matrix under a computing base, so an expected value Tr[Op] may be calculated theoretically through the following formula:

$$Tr [ O ρ ] = {\sum }_{i = 0}^{{2}^{n} - 1} O ( i ) ρ ( i )$$

where O(i) represents an element in row i, column i of O (assuming that an index of matrix elements is numbered starting with 0). The above quantum computing process may be shown in FIG. 1, a process that the quantum computer 101 generates the n-qubit quantum state ρ and the quantum state ρ is measured via a quantum measurement device 102 so as to obtain a measurement result is executed for M times, the number of times Mᵢ of an output result i is statistically calculated, ρ(i)≈Mᵢ/M is estimated, and then Tr[Op] may be estimated through the classical computer 103. For example, the quantum measurement device 102 may implement measurement for the n-qubit quantum state ρ through n (positive integer) single-qubit measurement devices 1021 so as to obtain the measurement result. A law of large numbers can guarantee that when M is big enough, the above estimation process is correct.

It can be understood that a combination of the quantum computer 101 and the quantum measurement device 102 is a quantum computer or a quantum device in the usual sense.

However, in physical implementation, due to limits of various factors such as instruments, methods and conditions, the quantum measurement device cannot work accurately, so a measurement noise is caused, and actually estimated values Mᵢ/M and ρ(i) have deviations, which leads to an error of computing Tr[Op] by using the above formula.

A source of the noise may be a classical noise or a quantum noise. Specifically, as for:

$$\begin{matrix}O = {\sum }_{x} {p}_{x} {Π}_{x} \\ Tr [ O ρ ] = {\sum }_{x} {p}_{x} T r [ {Π}_{x} ρ ]\end{matrix}$$

In an ideal situation that the quantum measurement device does not contain the noise, a corresponding positive operator-valued measure (POVM) is represented as:

Πⁱ={Πₓⁱ}ₓ

Πₓⁱ=|x [symbol] x|

where a superscript i represents that there is no noise (ideal). In a situation that the quantum measurement device contains the quantum noise, a corresponding positive operator-valued measure (POVM) is represented as:

$$\begin{matrix}{Π}^{q} = {\{ {Π}_{x}^{q} \}}_{x} \\ {\sum }_{x} {Π}_{x}^{q} = I\end{matrix}$$

where, Πₓ^{q} is a positive semi-definite matrix, and a superscript q represents the quantum noise. In a situation that the quantum measurement device contains only the classical noise, a corresponding positive operator-valued measure (POVM) is represented as:

$$\begin{matrix}{Π}^{c} = {\{ {Π}_{x}^{c} \}}_{x} \\ {Π}_{x}^{c} = {\sum }_{y ∈ {\{ 0 , 1 \}}^{n}} 〈 y \vert {Π}_{x}^{q} \vert y 〉 \vert y 〉 〈 y \vert = diag ( {Π}_{x}^{q} )\end{matrix}$$

where a superscript c represents the classical noise. The above x∈{0,1}ⁿ represents an output result of the quantum measurement device.

In other words, there may be an error when an output quantum state is measured through the above measurement base to determine a corresponding output result. As a consequence, the statistically calculated number of times Mᵢ of the output result i may be inaccurate.

If there is the quantum noise in the quantum measurement device, a quantum measurement tomography must be applied to the quantum measurement device, so all information of the noise can be obtained, and a work of error mitigation can be performed; and on the other hand, if there is only the classical noise in the quantum measurement device, a quantum measurement calibration only needs to be applied to the quantum measurement device, so all information of the noise can be obtained, and the work of error mitigation can be performed. Compared to the calibration method, the tomography method can extract more information, but more resources will be consumed.

Taking a single quantum bit as an example, it is assumed that a large quantity of |0 [symbol] states and |1 [symbol] states are prepared respectively, the measurement results are obtained after they are respectively measurement by the quantum measurement device, and it is discovered that probabilities of obtaining the measurement result x=0 are 0.9 and 0.2, respectively and probabilities of obtaining the measurement result x=1 are 0.1 and 0.8, respectively. Corresponding observable operators may be written:

$$\begin{matrix}{Π}_{0}^{q} = [ \begin{matrix}0.9 & {γ}_{1} \\ {γ}_{1}^{*} & 0.2\end{matrix} ] = [ \begin{matrix}0.9 & {a}_{1} + {ib}_{1} \\ {a}_{1} - {ib}_{1} & 0.2\end{matrix} ] \\ {Π}_{1}^{q} = [ \begin{matrix}0.1 & {γ}_{2} \\ {γ}_{2}^{*} & 0.8\end{matrix} ] = [ \begin{matrix}0.1 & {a}_{2} + {ib}_{2} \\ {a}_{2} - {ib}_{2} & 0.8\end{matrix} ]\end{matrix}$$

Due to

$${Π}_{0}^{q} + {Π}_{1}^{q} = [ \begin{matrix}1 & 0 \\ 0 & 1\end{matrix} ] ,$$

a relation between γ₁, γ₂ in numerical value can be determined. γ₁, γ₂ here are a source of the quantum noise and are usually quantities depicted only by the tomography method.

Both the quantum measurement device tomography method and the quantum measurement device calibration method are common technologies for error mitigation of the quantum measurement device.

The quantum measurement device tomography method prepares different input states and then measurement by the quantum measurement device, and a measurement operator Π^{q} is constructed according to statistical data of the measurement results. The measurement operator obtained through the tomography method can completely depict quantum noise properties of the quantum measurement device. Although the quantum noise can be described completely by the tomography method, the quantum state and the measurement base need to span over a whole quantum space, so the cost of tomography method is very high, and a needed resource is O(4ⁿ) (n is the quantity of quantum bits of the quantum measurement device).

The quantum measurement device calibration method constructs a classical matrix Π^{c} by calibration data generated by running a calibrating circuit, the matrix depicts classical noise information of the noise-containing quantum measurement device, and when a certain specific quantum computing task needs to be executed subsequently, noise-containing output data generated by a quantum circuit corresponding to the task may be processed by using the obtained calibration matrix HC, so that an error of the output data is mitigated.

For example, in the process of error mitigation of the measurement device by using the calibration method, in general, the measurement device may be calibrated firstly, then an output result of the measurement device is corrected, and a work flow may be shown in FIG. 2. In the basic flow of measurement noise processing, experiment personnel prepare a lot of calibrating circuits firstly (step 210), and then run these calibrating circuits in an actual measurement device (step 220) so as to detect basis information of the measurement device. Specifically, corresponding calibrating circuits may be constructed in a system shown in FIG. 1 through the quantum computer 101 so as to obtain a corresponding standard base quantum state. The standard base quantum state is repeatedly measured through the measurement device 102 to generate the calibration data (step 230). The calibration matrix A may be constructed by using the generated calibration data (step 240), and the matrix depicts the classical noise information of the noise-containing measurement device. When a certain specific quantum computing task needs to be executed subsequently, the quantum circuit corresponding to the computing task may be constructed firstly (step S10), the quantum circuit corresponding to the task may be run in the actual device (step S20), and the noise-containing output data {Mᵢ}ᵢ of the quantum circuit is obtained (step S30). Afterwards, these noise-containing data may be post-processed by using the obtained calibration matrix A (step S40):

$$q = ( \begin{matrix}{M}_{0} / M \\ {M}_{1} / M \\ ⋮ \\ {M}_{{2}^{n} - 1} / M\end{matrix} ) , \qquad p = {A}^{- 1} q$$

where, A⁻¹ represents an inverse of the calibration matrix A. A probability distribution p after being calibrated approximates {ρ(i)}ᵢ, and then an expected value Tr[Op] is calculated (step S50), so that an influence of the classical noise can be effectively eliminated, and an accuracy of the calculated expected value is improved.

Though needing relatively fewer computing resources, the quantum measurement device calibration method can depict only the classical noise. The classical noise can reflect only a part of sources of the noise of the measurement device, such as statistical errors which are noise capable of being mitigated in subsequent data processing through a statistical method. However, if the quantum noise of the quantum measurement device is dominant, a main source of the noise is the quantum noise, and an error of the noise-containing measurement data obtained at the moment cannot be accurately mitigated in spite of brilliant statistical measures.

Therefore, how to estimate the quantum noise intensity in the quantum measurement device efficiently and fast will be necessary. Either the quantum measurement device tomography method or the quantum measurement device calibration method is dynamically decided based on the estimated quantum noise intensity to process the noise of the quantum measurement device, so that the resources consumed by quantum measurement noise processing are saved.

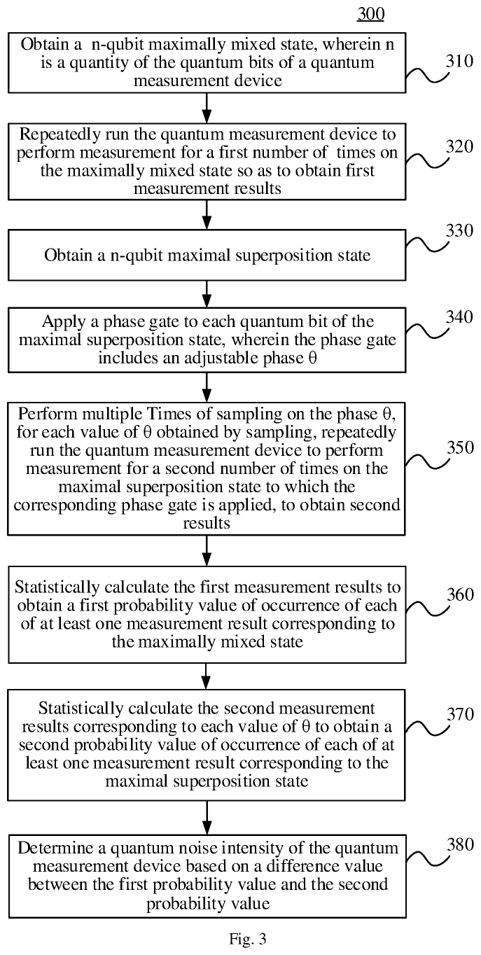

According to the embodiment of the present disclosure, a method for determining a quantum noise intensity of a quantum measurement device is provided. FIG. 3 shows a flowchart of a method for determining a quantum noise intensity according to an embodiment of the present disclosure. As shown in FIG. 3, the method 300 includes: a n-qubit maximally mixed state is obtained, wherein n is a quantity of quantum bits of the quantum measurement device (step 310); the quantum measurement device is repeatedly run to perform measurement for a first number of times on the maximally mixed state so as to obtain first measurement results (step 320); a n-qubit maximal superposition state is obtained (step 330); a phase gate is applied to each qubit of the maximal superposition state, wherein the phase gate includes an adjustable phase θ (step 340); multiple times of sampling is performed on the phase θ, and for each value of θ obtained by sampling, the quantum measurement device is repeatedly run to perform measurement for a second number of times on the maximal superposition state to which the corresponding phase gate is applied, so as to obtain second measurement results (step 350); the first measurement result of the maximally mixed state is statistically calculated so as to obtain a first probability value of occurrence of each of at least one measurement result corresponding to the maximally mixed state (step 360); the second measurement result of the maximal superposition state corresponding to each value of θ is statistically calculated so as to obtain a second probability value of occurrence of each of at least one measurement result corresponding to the maximal superposition state (step 370); and the quantum noise intensity of the quantum measurement device is determined based on a difference value between the first probability value and the second probability value (step 380).

According to the embodiment of the present disclosure, the quantum noise intensity under various conditions can be efficiently estimated through the maximally mixed state and the maximal superposition state obtained after phase gate modulation, then whether all information of the quantum measurement device needs to be depicted by consuming more resources can be judged based on the determined quantum noise intensity, and thus an accuracy of a computing result is improved.

The measurement result obtained by measurement for the corresponding quantum state through the quantum measurement device is a binary string, that is, the measurement result is x, x∈{0,1}ⁿ. Different forms of x are different measurement results. The number of times of occurrence of one or more preset measurement results (for example, all possible measurement results) may be statistically calculated so as to obtain a probability distribution of the one or more measurement results.

It can be understood that through the method of the present disclosure, probability distributions of all the measurement results (x∈{0,1}ⁿ) can be determined.

In the present disclosure, a variable parameter θ is introduced through the phase gate, the quantum noise intensity under various situations may be estimated by constantly adjusting a parameter value of the variable parameter, and an application scene of the method of the present disclosure and an estimation accuracy of the quantum noise are greatly improved. In other words, according to the method of the present disclosure, the quantum noise intensity may not only be determined when a sum of nondiagonal elements of POVM elements is not equal to zero (corresponding to the parameter θ of a phase gate is equal to 0), but also be accurately judged when the sum of the nondiagonal elements of the POVM elements is equal to 0.

For example, in an embodiment according to the present disclosure, estimating the quantum noise intensity of the quantum measurement device of the n quantum bits may include the following steps:

First step: prepare a maximally mixed state:

$$π = \frac{1}{{2}^{n}} ,$$

I being a unit matrix of 2ⁿ-dimension.

Second step: repeatedly run the noise-containing quantum measurement device for a total of N₁ times, and statistically calculate the number of times N_{x|π} of an output result being a binary string x, where x∈{0,1}ⁿ, ΣₓN_{x|π}=N₁.

Third step: prepare a maximal superposition state

$$Φ = \frac{1}{{2}^{n}} {\sum }_{y , z ∈ {\{ 0 , 1 \}}^{n}} \vert y \text{><} z \vert ,$$

y and z being both binary strings, namely, y, z∈{0,1}ⁿ.

Fourth step: apply a phase gate U(θ)=(|0 [symbol] 0|+e^{iθ}|1 [symbol] 1)^{⊗n} to each quantum bit of the maximal superposition state, so as to obtain a quantum state:

$${Φ}_{θ} = \frac{1}{{2}^{n}} {\sum }_{y , z ∈ {\{ 0 , 1 \}}^{n}} {e}^{i θ ( \vert y \vert - \vert z \vert} \vert y \text{><} z \vert$$

where |y| and |z| represent a Hamming weight of y and a Hamming weight of z, respectively, namely, the number of “1” contained in each of y and z.

Fifth step: perform sampling operation on different phases θ to, as for each θ, repeatedly run the noise-containing measurement device for a total of N₂ times, and statistically calculate the number of times N_{x|Φ}^{θ} of an output result being a binary string x, where x∈{0,1}ⁿ, ΣₓN_{x|Φ}^{θ}=N₂.

Sixth step: perform normalization processing on an obtained data set, a probability distribution of an output result can be obtained by dividing the number of running times N₁ or N₂ of the corresponding measurement device, shown as follows:

P_{x|Π}=N_{x|Π}/N₁

P_{x|Φ}=N_{x|Φ}^{θ}/N₂.

As described above, it can obtain:

$$\begin{matrix}{P}_{x \vert π} = {\sum }_{y ∈ {\{ 0 , 1 \}}^{n}} \frac{{Π}_{x}^{q} ( y , y )}{{2}^{n}} \\ {P}_{x \vert Φ}^{θ} = \frac{{N}_{x \vert Φ}^{θ}}{{N}_{s h o t s}} = {\sum }_{y ∈ {\{ 0 , 1 \}}^{n}} \frac{{Π}_{x}^{q} ( y , y )}{{2}^{n}} + {\sum }_{y , z ∈ {\{ 0 , 1 \}}^{n} , y \neq z} \frac{{e}^{i θ ( \vert y \vert - \vert z \vert )} {Π}_{x}^{q} ( y , z )}{{2}^{n}}\end{matrix}$$

where Πₓ^{q}(y, z)= [symbol] y|Πₓ^{q}|z [symbol] represents an element in row y, column z of Πₓ^{q}, and Πₓ^{q}(y, y) is similar to this.

It is proved theoretically that a statistical result of the maximally mixed state depicts only a magnitude of the classical noise, a measurement result of the maximal superposition state obtained after phase gate modulation depicts magnitudes of both the classical noise and the quantum noise, and a difference value between them may be depicted by a Fourier series expansion. Therefore, experimental statistical data may be fitted according to a preset Fourier series expansion, and a result obtained through fitting may be used for quantitatively depicting the quantum noise intensity.

Specifically, by comparing the expressions P_{x|π} and P_{x|Φ}^{θ} above, it can be seen that a difference value between them depicts the intensity of the quantum noise in a certain degree. The probability distributions corresponding to two input states are subtracted and multiplied by 2ⁿ so as to obtain:

$${g}_{x}^{θ} = {2}^{n} ( {P}_{x \vert π} - {P}_{x \vert Φ}^{θ} ) = {\sum }_{y , z ∈ {\{ 0 , 1 \}}^{n} , y \neq z} - {Π}_{x}^{q} ( y , z ) {e}^{i θ ( \vert y \vert - \vert z \vert )}$$

The above formula is subjected to Fourier series expanding so as to obtain the corresponding Fourier series expansion:

$${g}_{x}^{θ} = 2 [ {\sum }_{y , z ∈ {\{ 0 , 1 \}}^{n} , y < z} - cos [ θ ( \vert y \vert - \vert z \vert ) ] ℜ [ {Π}_{x}^{q} ( y , z ) ] + sin [ θ ( \vert y \vert - \vert z \vert ) ] 𝔍 [ {Π}_{x}^{q} ( y , z ) ] ]$$

where a coefficient 2 utilizes a conjugation property of a POVM operator, and [symbol] i(x) and ℑ(x) represent a real part and an imaginary part of row y, column z of a measurement result matrix, respectively. It can be seen that under the action of the phase gate, a set of complete orthogonal bases [symbol] cos(mθ), sin(mθ) [symbol] are obtained, where m=(|y|−|z|)∈[0,n], and n is the quantity of quantum bits. Thus, each nondiagonal element of the POVM elements may be expanded under the set of bases, and coefficients of expansion are the sum of the nondiagonal elements of POVM elements with the same Hamming weight difference (namely, m=(|y|−|z|)). It can be seen that [symbol] cos(mθ) [symbol] extracts real number information of the nondiagonal elements, and [symbol] sin(mθ) [symbol] extracts imaginary number information of the nondiagonal elements.

Accordingly, function fitting is performed according to the form of the above Fourier series expansion, so the corresponding coefficients may be obtained. According to some embodiments, determining the quantum noise intensity of the quantum measurement device may include: for each of the at least one measurement result, function fitting is performed according to a preset Fourier series expansion based on all values of θ obtained by sampling and the corresponding difference value; and a coefficient of the Fourier series expansion obtained by fitting is determined so as to determine the quantum noise intensity of the quantum measurement device based on the coefficient.

Specifically, taking 2 bits as an example,

$${Φ}_{θ} = [ \begin{matrix}1 & {e}^{- i θ} & {e}^{- i θ} & {e}^{- i 2 θ} \\ {e}^{i θ} & 1 & 1 & {e}^{- i θ} \\ {e}^{i θ} & 1 & 1 & {e}^{- i θ} \\ {e}^{i 2 θ} & {e}^{i θ} & {e}^{i θ} & 1\end{matrix} ] / 4 ,$$

$${g}_{x}^{θ} = 2 [ - {a}_{0} - {a}_{1} cos ( θ ) - {a}_{2} cos ( 2 θ ) + {b}_{1} sin ( θ ) + {b}_{2} sin ( 2 θ ) ] ,$$

$$where$$

$$\{ \begin{matrix}{a}_{0} = ℜ ( < 10 \vert {Π}_{x} \vert 01 > ) , \\ {a}_{1} = ℜ ( < 01 \vert {Π}_{x} \vert 00 > + < 01 \vert {Π}_{x} \vert 00 > + < 11 \vert {Π}_{x} \vert 01 > + < 11 \vert {Π}_{x} \vert 10 > ) , \\ {a}_{2} = ℜ ( < 11 \vert {Π}_{x} \vert 00 > ) , \\ {b}_{1} = 𝔍 ( < 01 \vert {Π}_{x} \vert 00 > + < 01 \vert {Π}_{x} \vert 00 > + < 11 \vert {Π}_{x} \vert 01 > + < 11 \vert {Π}_{x} \vert 10 > ) , \\ {b}_{2} = 𝔍 ( < 11 \vert {Π}_{x} \vert 00 > ) .\end{matrix}$$

It can be seen that each coefficient according to the Fourier series expansion depicts the quantum noise intensity of an output result being a binary string x. Thus, as for the output result x, function fitting is performed on a difference value corresponding to each θ corresponding to the output result according to the above formula gₓ^{θ} so as to obtain values of coefficients a₀, a₁, a₂, b₁ and b₂ corresponding to the current output result x. a₀ represents real number information of an element in row 3, column 2 of POVM elements, and a₁ represents a sum of real number information of an element in a row 2, column 1, the element in the row 2, column 1, an element in a row 4, column 2 and the element in the row 4, column 2 of the POVM elements . . . . The nondiagonal elements of the POVM elements may be determined based on the above coefficient. By comparing the nondiagonal element (namely, g^{θ}) of the POVM elements corresponding to a preset θ, or the nondiagonal element (namely, gₓ) of the POVM elements corresponding to the current output result x with a preset error-tolerant rate c, whether a quantum noise effect is dominant can be judged.

For example, if a coefficient aₘ or bₘ corresponding to a preset nondiagonal element meets aₘ>>∈ or bₘ>>∈, it can be regarded as the quantum noise being dominant, and at the moment, error mitigation may be performed on the noise-containing measurement device by using a measurement tomography technology; and if aₘ<<∈ and bₘ<<∈, it can be regarded as the quantum noise being lower, and at the moment, error mitigation can be performed on the noise-containing measurement device by using a measurement calibration technology.

It can be understood that a value range of the phase θ is [0, 2π]. Moreover, the larger the number of times of sampling for the phase θ (the more comprehensive the value of the phase θ is), the more accurate depiction of the quantum noise is. Accordingly, the number of times of sampling may be preset according to actual demands.

In some embodiments, as for one or more preset measurement results x (for example, all possible measurement results x), the nondiagonal elements (determined based on the coefficients obtained by fitting) corresponding to them may be added respectively to compare the added nondiagonal elements with a preset error-tolerant rate c so as to judge a quantum noise level for a specific measurement result of the quantum measurement device.

The method of the present disclosure may be applied to all types of quantum measurement device to depict the quantum noise intensity of the quantum measurement device, and even for the measurement device with the non-dominant quantum noise intensity, the method may also be used for obtaining a magnitude of a sum of nondiagonal elements of Πₓ^{q}, that is, a magnitude of gₓ, so that the quantum noise intensity of the quantum measurement device is determined.

According to some embodiments, the maximally mixed state is obtained through a preset first quantum circuit. The first quantum circuit includes n quantum bits in a ground state, n H gates, n auxiliary quantum bits and n controlled-NOT gates. The n H gates act on the n quantum bits in the ground state respectively, the controlled-NOT gates act between the n quantum bits and the corresponding auxiliary quantum bits respectively after the acting of the H gates, and the n quantum bits in the ground state are in one-to-one correspondence with the n auxiliary quantum bits.

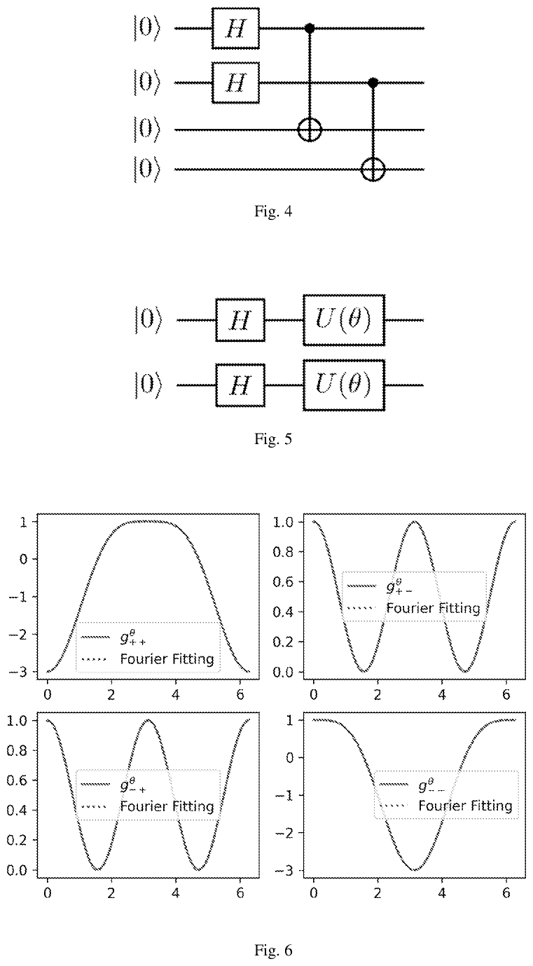

Specifically, the maximally mixed state may be prepared through a “purification” method. Taking preparing the maximally mixed state corresponding to 2 quantum bits as an example, the 2 quantum bits in the ground state are obtained, and 2 auxiliary quantum bits are additionally introduced. The four quantum bits are matched pairwise, the first quantum bit is matched with the third quantum bit so as to prepare an entangled state, and the second quantum bit is matched with the fourth quantum bit. Finally, only half of the matched quantum bits are observed, that is, only the first two quantum bits or the last two quantum bits are observed, so an observed result corresponding to the maximally mixed state is obtained. Preparation of the entangled state may be used to apply an H gate to a quantum bit in a quantum bit pair, and then make a CNot gate (the controlled-NOT gate) act on the other quantum bit, as shown in a diagram of a quantum circuit in FIG. 4.

It can be understood that this is only an exemplary method for preparing the maximally mixed state, and other optional methods for preparing the maximally mixed state are also included, which is not limited to using a 10) state as an input and is not repeated here.

According to some embodiments, the maximal superposition state is obtained through a preset second quantum circuit. The second quantum circuit includes n quantum bits in the ground state and n H gates. The n H gates act on n quantum bits in the ground state respectively.

Specifically, taking preparing the maximal superposition state corresponding to 2 quantum bits as an example, preparation of the maximal superposition state may be obtained by adding an H gate to the 2 quantum bits in the ground state. Furthermore, the phase gate is applied to each quantum bit in the obtained maximal superposition state, so a phase-modulated maximal superposition state is obtained, as shown in FIG. 5.

It can be understood that this is only an exemplary method for preparing the maximal superposition state, and other optional methods for preparing the maximal superposition state are also included, which is not limited to using a |0 [symbol] state as an input and is not repeated here.

In an exemplary application of the method according to the embodiment of the present disclosure, in order to make a fitting process more visual, a noise-containing measurement of a relatively ideal Pauli Z measurement is simulated through a Pauli X measurement. For example, the Pauli X measurement may be obtained by making the H (Hadamard) gate act before the Pauli Z measurement, which will introduce a real number to the nondiagonal elements of the POVM elements corresponding to the Pauli Z measurement. Under the Pauli X measurement, taking 2 bits as an example, the following POVM elements may be obtained:

$${Π}_{+ +} = \frac{1}{4} [ \begin{matrix}1 & 1 & 1 & 1 \\ 1 & 1 & 1 & 1 \\ 1 & 1 & 1 & 1 \\ 1 & 1 & 1 & 1\end{matrix} ] ,$$

$${Π}_{\pm } = \frac{1}{4} [ \begin{matrix}1 & - 1 & 1 & - 1 \\ - 1 & 1 & - 1 & 1 \\ 1 & - 1 & 1 & - 1 \\ - 1 & 1 & - 1 & 1\end{matrix} ] ,$$

$${Π}_{∓} = \frac{1}{4} [ \begin{matrix}1 & 1 & - 1 & - 1 \\ 1 & 1 & - 1 & - 1 \\ - 1 & - 1 & 1 & 1 \\ - 1 & - 1 & 1 & 1\end{matrix} ] ,$$

$${Π}_{- -} = \frac{1}{4} [ \begin{matrix}1 & - 1 & - 1 & 1 \\ - 1 & 1 & 1 & - 1 \\ - 1 & 1 & 1 & - 1 \\ 1 & - 1 & - 1 & 1\end{matrix} ] .$$

therefore, corresponding gₓ^{θ} may be obtained, as shown as follows:

$$\{ \begin{matrix}{g}_{+ +}^{θ} = 2 [ - 0.25 - cos ( θ ) - 0.25 cos ( 2 θ ) ] , \\ {g}_{\pm }^{θ} = 2 [ 0.25 + 0.25 cos ( 2 θ ) ] , \\ {g}_{∓}^{θ} = 2 [ 0.25 + 0.25 cos ( 2 θ ) ] , \\ {g}_{- -}^{θ} = 2 [ - 0.25 + cos ( θ ) - 0.25 cos ( 2 θ ) ] .\end{matrix}$$

After a theoretical calculating value is obtained, the quantum circuit is built on a LocalBaiduSim2 quantum simulator according to the above solution, a value range of θ is [0, 2π] (e.g. x-axis), and a noise curve and a Fourier Fitting curve shown in FIG. 6 and fitting data shown in Table 1 are obtained.

TABLE 1
Fitting result

| POVM | | | | | |
|---|---|---|---|---|---|
| elements | a₀ | a₁ | a₂ | b₁ | b₂ |
| Π₊₊ | 0.25 | 1.00 | 0.25 | 0.00 | 0.00 |
| Π₊ | −0.25 | 0.00 | −0.25 | 0.00 | 0.00 |
| Π_{∓} | −0.25 | 0.00 | −0.25 | 0.00 | 0.00 |
| Π₋₋ | 0.25 | −1.00 | 0.25 | 0.00 | 0.00 |

It can be seen according to FIG. 6 and Table 1 that a fitting result is equal to a theoretical value, which proves that the method according to the embodiment of the present disclosure is effective.

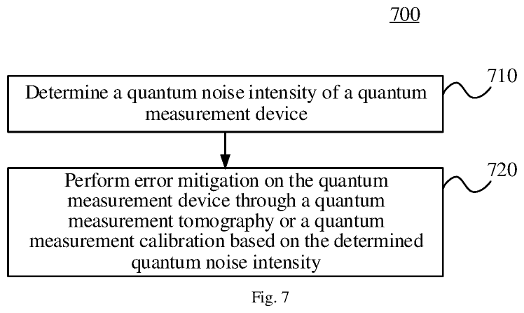

Thus, as shown in FIG. 7, according to the embodiment of the present disclosure, a method 700 for error mitigation of a quantum measurement device is further provided and includes: a quantum noise intensity of the quantum measurement device is determined (step 710); and error mitigation is performed on the quantum measurement device through a quantum measurement device tomography method or a quantum measurement device calibration method based on the determined quantum noise intensity (step 720). The quantum noise intensity of the quantum measurement device may be determined based on the method of any one of above embodiments.

For example, when it is determined that the quantum noise intensity of the quantum measurement device is dominant (corresponding aₘ>>∈ or bₘ>>∈) through the method of the above embodiment, error mitigation is performed on the quantum measurement device through the quantum measurement device tomography method; or otherwise, error mitigation is performed on the quantum measurement device through the quantum measurement device calibration method.

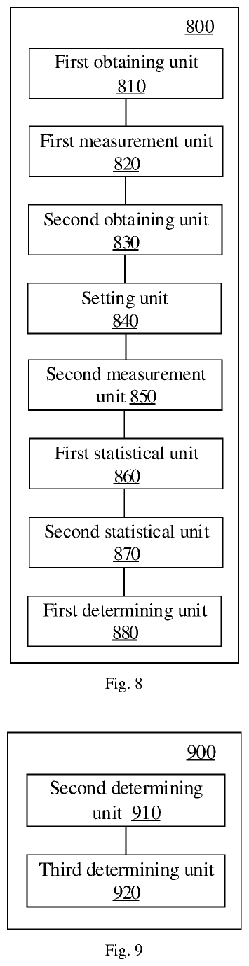

According to an embodiment of the present disclosure, as shown in FIG. 8, an apparatus 800 for determining a quantum noise intensity of a quantum measurement device is further provided and includes: a first obtaining unit 810, configured to obtain a n-qubit maximally mixed state, wherein n is a quantity of quantum bits of the quantum measurement device; a first measurement unit 820, configured to repeatedly run the quantum measurement device to perform measurement for a first number of times on the maximally mixed state to obtain first measurement results; a second obtaining unit 830, configured to obtain a n-qubit maximal superposition state; a setting unit 840, configured to apply a phase gate to each quantum bit of the maximal superposition state, wherein the phase gate includes an adjustable phase θ; a second measurement unit 850, configured to perform multiple times of sampling on the phase θ, and for each value of θ obtained by sampling, repeatedly run the quantum measurement device to perform measurement for a second number of times e on the maximal superposition state to which the corresponding phase gate is applied, to obtain second measurement results; a first statistical unit 860, configured to statistically calculate the first measurement results to obtain a first probability value of occurrence of each of at least one measurement result corresponding to the maximally mixed state; a second statistical unit 870, configured to statistically calculate the second measurement results corresponding to each value of θ to obtain a second probability value of occurrence of each of at least one measurement result corresponding to the maximal superposition state; and a first determining unit 880, configured to determine the quantum noise intensity of the quantum measurement device based on a difference value between the first probability value and the second probability value.

Here, operations of the above units 810 to 880 of the apparatus 800 for determining the quantum noise intensity of the quantum measurement device are similar to operations of step 310 to 380 described above respectively and will not be repeated here.

According to the embodiment of the present disclosure, as shown in FIG. 9, an apparatus 900 for error mitigation of the quantum measurement device is further provided and includes: a second determining unit 910, configured to determine a quantum noise intensity of the quantum measurement device; and a third determining unit 920, configured to perform error mitigation on the quantum measurement device through a quantum measurement device tomography method or a quantum measurement device calibration method based on the determined quantum noise intensity. The quantum noise intensity of the quantum measurement device may be determined based on the method of any one of above embodiments.

According to an embodiment of the present disclosure, an electronic device, a readable storage medium and a computer program product are further provided.

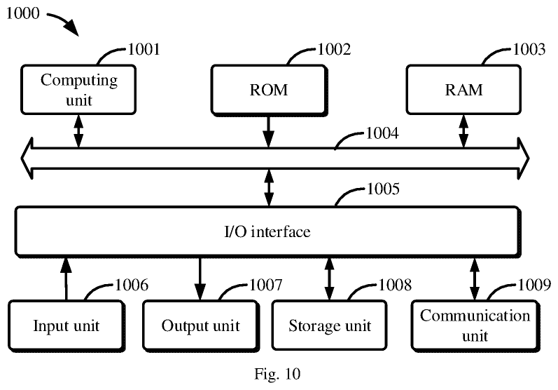

Referring to FIG. 10, a structural block diagram of an electronic device 1000 capable of serving as a server or a client of the present disclosure is described now, which is an example of a hardware device applicable to various aspects of the present disclosure. The electronic device intends to represent various digital electronic computer devices, such as a laptop computer, a desktop computer, a workbench, a personal digital assistant, a server, a blade server, a mainframe computer and other suitable computers. The electronic device may also represent various mobile devices, such as a personal digital assistant, a cell phone, a smartphone, a wearable device and other similar computing apparatuses. Components shown herein, their connections and relations and their functions are only examples and do not intend to limit implementation of the present disclosure described and/or required herein.

As shown in FIG. 10, the electronic device 1000 includes a computing unit 1001, which can execute various appropriate actions and processing according to a computer program stored in a read-only memory (ROM) 1002 or a computer program loaded from a storage unit 1008 to a random access memory (RAM) 1003. The RAM 1003 can also store various programs and data needed by operations of the electronic device 1000. The computing unit 1001, the ROM 1002 and the RAM 1003 are mutually connected through a bus 1004. An input/output (I/O) interface 1005 is also connected to the bus 1004.

A plurality of components in the electronic device 1000 are connected to the I/O interface 1005, including: an input unit 1006, an output unit 1007, the storage unit 1008, and a communication unit 1009. The input unit 1006 may be any type of devices capable of inputting information to the electronic device 1000 and can receive input number or character information and generate key signal inputs related to user setting and/or function control of the electronic device and can include but is not limited to a mouse, a keyboard, a touch screen, a trackpad, a trackball, a joystick, a microphone and/or a remote-control unit. The output unit 1007 may be any type of device capable of displaying information and may include but is not limited to a display, a speaker, a video/audio output terminal, a vibrator and/or a printer. The storage unit 1008 may include but is not limited to a magnetic disk and a compact disc. The communication unit 1009 allows the electronic device 1000 to exchange information/data with other devices through a computer network, such as Internet, and/or various telecommunication networks and may include but is not limited to a modem, a network card, an infrared communication device, a wireless communication transceiver and/or a chipset, for example, a Bluetooth™ device, a 802.11 device, a WiFi device, a WiMax device, a cellular communication device and/or similar items.

The computing unit 1001 may be various general-purpose and/or special-purpose processing components with processing and computing capacity. Some examples of the computing unit 1001 include but are not limited to a central processing unit (CPU), a graphics processing unit (GPU), various special-purpose artificial intelligence (AI) computing chips, various computing units for running a machine learning model algorithm, a digital signal processor (DSP), and any appropriate processor, controller, microcontroller and the like. The computing unit 1001 executes each method and processing described above, for example, the method 300 or 700. For example, in some embodiments, the method 300 or 700 may be realized as a computer software program, which is tangibly contained in a machine-readable medium, for example, the storage unit 1008. In some embodiments, a part of or all of the computer programs may be loaded and/or installed onto the electronic device 1000 via the ROM 1002 and/or the communication unit 1009. When the computer program is loaded to the RAM 1003 and executed by the computing unit 1001, one or more steps of the method 300 or 700 described above can be executed. Alternatively, in other embodiments, the computing unit 1001 may be configured to execute the method 300 or 700 in any other appropriate mode (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a complex programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally away from each other and usually interact through a communication network. A relation between the client and the server is generated by running a computer program with a mutual client-server relation on a corresponding computer. The server may be a cloud server, or a server of a distributed system, or a server combined with a blockchain.

It should be understood that steps can be reranked, added or deleted by using various forms of flows shown above. For example, all the steps recorded in the present disclosure can be executed in parallel, or in sequence or in different orders, which is not limited herein as long as a desired result of the technical solutions disclosed by the present disclosure can be realized.

Though the embodiments or the examples of the present disclosure are already described with reference to the accompanying drawings, it should be understood that the above method, system or device is only an exemplary embodiment or example, and the scope of the present disclosure is not limited by these embodiments or examples but limited only by the scope of the authorized claims and their equivalents. Various elements in the embodiments or the examples may be omitted or replaced by their equivalent elements. Besides, all the steps may be executed in sequence different from a sequence described in the present disclosure. Furthermore, various elements in the embodiments or the examples may be combined in various modes. What counts is that with technology evolution, many elements described here can be replaced with equivalent elements appearing after the present disclosure.

What is claimed is:

1. A computer-implemented method, comprising:
obtaining a n-qubit maximally mixed state, wherein n is a quantity of quantum bits of a quantum measurement device;
repeatedly running the quantum measurement device to perform measurement for a first number of times on the maximally mixed state to obtain first measurement results;
obtaining a n-qubit maximal superposition state;
applying a phase gate to each quantum bit of the maximal superposition state, wherein the phase gate comprises an adjustable phase θ;
performing multiple times of sampling on the phase θ, and for each value of θ obtained by sampling, repeatedly running the quantum measurement device to perform measurement for a second number of times on the maximal superposition state to which the corresponding phase gate is applied, to obtain second measurement results;
statistically calculating the first measurement results to obtain a first probability value of occurrence of each of at least one measurement result corresponding to the maximally mixed state;
statistically calculating the second measurement results corresponding to each value of θ to obtain a second probability value of occurrence of each of at least one measurement result corresponding to the maximal superposition state; and
determining a quantum noise intensity of the quantum measurement device based on a difference value between the first probability value and the second probability value.

2. The method according to claim 1, wherein the determining the quantum noise intensity of the quantum measurement device comprises:
performing, for each of the at least one measurement result, function fitting according to a preset Fourier series expansion based on all values of θ obtained by sampling and the corresponding difference value; and
determining a coefficient of the Fourier series expansion obtained by function fitting to determine the quantum noise intensity of the quantum measurement device based on the coefficient.

3. The method according to claim 1, wherein the maximally mixed state is obtained through a preset first quantum circuit, wherein
the first quantum circuit comprises n quantum bits in a ground state, n H gates, n auxiliary quantum bits and n controlled-NOT gates, and
wherein the n H gates act on the n quantum bits in the ground state respectively, and the n controlled-NOT gates act between the n quantum bits and the corresponding n auxiliary quantum bits respectively after the acting of the n H gates, and wherein the n quantum bits in the ground state are in one-to-one correspondence with the n auxiliary quantum bits.

4. The method according to claim 1, wherein the maximal superposition state is obtained through a preset second quantum circuit, wherein
the second quantum circuit comprises n quantum bits in a ground state and n H gates, and
wherein the n H gates act on the n quantum bits in the ground state respectively.

5. A method for error mitigation of a quantum measurement device, comprising:
determining a quantum noise intensity of the quantum measurement device; and
performing error mitigation on the quantum measurement device through a quantum measurement device tomography method or a quantum measurement device calibration method based on the determined quantum noise intensity, wherein
the quantum noise intensity of the quantum measurement device is determined by implementing operations comprising:
obtaining a n-qubit maximally mixed state, wherein n is a quantity of quantum bits of a quantum measurement device;
repeatedly running the quantum measurement device to perform measurement for a first number of times on the maximally mixed state to obtain first measurement results;
obtaining a n-qubit maximal superposition state;
applying a phase gate to each quantum bit of the maximal superposition state, wherein the phase gate comprises an adjustable phase θ;
performing multiple times of sampling on the phase θ, and for each value of θ obtained by sampling, repeatedly running the quantum measurement device to perform measurement for a second number of times on the maximal superposition state to which the corresponding phase gate is applied, to obtain second measurement results;
statistically calculating the first measurement results to obtain a first probability value of occurrence of each of at least one measurement result corresponding to the maximally mixed state;
statistically calculating the second measurement results corresponding to each value of θ to obtain a second probability value of occurrence of each of at least one measurement result corresponding to the maximal superposition state; and
determining a quantum noise intensity of the quantum measurement device based on a difference value between the first probability value and the second probability value.

6. The method according to claim 5, wherein the determining the quantum noise intensity of the quantum measurement device comprises:
performing, for each of the at least one measurement result, function fitting according to a preset Fourier series expansion based on all values of θ obtained by sampling and the corresponding difference value; and
determining a coefficient of the Fourier series expansion obtained by function fitting to determine the quantum noise intensity of the quantum measurement device based on the coefficient.

7. The method according to claim 5, wherein the maximally mixed state is obtained through a preset first quantum circuit, wherein
the first quantum circuit comprises n quantum bits in a ground state, n H gates, n auxiliary quantum bits and n controlled-NOT gates, and
wherein the n H gates act on the n quantum bits in the ground state respectively, and the n controlled-NOT gates act between the n quantum bits and the corresponding n auxiliary quantum bits respectively after the acting of the n H gates, and wherein the n quantum bits in the ground state are in one-to-one correspondence with the n auxiliary quantum bits.

8. The method according to claim 5, wherein the maximal superposition state is obtained through a preset second quantum circuit, wherein
the second quantum circuit comprises n quantum bits in a ground state and n H gates, and
wherein the n H gates act on the n quantum bits in the ground state respectively.

9. An electronic device, comprising:
a memory storing one or more programs configured to be executed by one or more processors, the one or more programs including instructions for causing the electronic device to perform operations comprising:
obtaining a n-qubit maximally mixed state, wherein n is a quantity of quantum bits of a quantum measurement device;
repeatedly running the quantum measurement device to perform measurement for a first number of times on the maximally mixed state to obtain first measurement results;
obtaining a n-qubit maximal superposition state;
applying a phase gate to each quantum bit of the maximal superposition state, wherein the phase gate comprises an adjustable phase θ;
performing multiple times of sampling on the phase θ, and for each value of θ obtained by sampling, repeatedly running the quantum measurement device to perform measurement for a second number of times on the maximal superposition state to which the corresponding phase gate is applied, to obtain second measurement results;
statistically calculating the first measurement results to obtain a first probability value of occurrence of each of at least one measurement result corresponding to the maximally mixed state;
statistically calculating the second measurement results corresponding to each value of θ to obtain a second probability value of occurrence of each of at least one measurement result corresponding to the maximal superposition state; and
determining a quantum noise intensity of the quantum measurement device based on a difference value between the first probability value and the second probability value.

10. The electronic device according to claim 9, wherein the determining the quantum noise intensity of the quantum measurement device comprises:
performing, for each of the at least one measurement result, function fitting according to a preset Fourier series expansion based on all values of θ obtained by sampling and the corresponding difference value; and
determining a coefficient of the Fourier series expansion obtained by function fitting to determine the quantum noise intensity of the quantum measurement device based on the coefficient.

11. The electronic device according to claim 9, wherein the maximally mixed state is obtained through a preset first quantum circuit, wherein
the first quantum circuit comprises n quantum bits in a ground state, n H gates, n auxiliary quantum bits and n controlled-NOT gates, and
wherein the n H gates act on the n quantum bits in the ground state respectively, and the n controlled-NOT gates act between the n quantum bits and the corresponding n auxiliary quantum bits respectively after the acting of the n H gates, and wherein the n quantum bits in the ground state are in one-to-one correspondence with the n auxiliary quantum bits.

12. The electronic device according to claim 9, wherein the maximal superposition state is obtained through a preset second quantum circuit, wherein
the second quantum circuit comprises n quantum bits in a ground state and n H gates, and
wherein the n H gates act on the n quantum bits in the ground state respectively.
